(19) United States
(12) Patent Application Publication
(10) Pub. No.: US 2010/0071225 A1
(43) Pub. Date: Mar. 25, 2010

(54) Portable cooler drying frame

(76) Inventor: Shannon Ross, Winter Garden, FL (US)

Correspondence Address: Arthur M. Peslak, Esq.;Mandel & Peslak, LLC, Suite 5, 80 Scenic Drive, Freehold, NJ, 07728-5211, US

(21) Appl. No.: 12/378,625

(22) Filed: Feb. 18, 2009

Related U.S. Application Data
(60) Provisional application No. 61/098,340, filed on Sep. 19, 2008.

(51) Int. Cl. F26B 25/00

(52) U.S. Cl. 34/239

(57) ABSTRACT

What is disclosed is frame adapted to be used in combination with a portable cooler to facilitate the drying of moisture from the portable cooler after use. The frame is comprised of a base section, a cooler support section, and a lid support section.

### PRIORITY CLAIM

This application claims priority to U.S. Provisional Application No. 61/098,340 filed Sep. 19, 2008.

### BACKGROUND OF THE INVENTION

The present invention relates to the field of portable coolers that are used to keep food or beverage items cold. Generally, ice is placed inside the cooler with the food and beverage items to maintain a low enough temperature to ensure freshness of the food items as well as a cold temperature for the beverages. After a period of time in the outdoors, the ice begins to melt significantly leaving the inside of the cooler wet.

The present invention is directed to a device that can be used to facilitate the drying process of the cooler after use. If the cooler is stored with moisture inside, mold potentially may form on the inside surfaces of the cooler. Thus, there is a need for a device that can be used to facilitate the drying process. The primary object of the present invention is to provide a simple easy to use device for facilitating the cooler drying process.

### SUMMARY OF THE INVENTION

A cooler drying frame comprising of a base section adapted to be placed on a horizontal surface, a cooler support section connected to the base section comprising a first top support extending upward therefrom and generally perpendicular thereto and a lid support section connected to the base section comprising a second top support and extending upward therefrom and generally perpendicular thereto wherein the cooler support section is adapted to receive an inverted cooler with a opened lid thereon whereby an inside bottom surface of the cooler rests upon the first top support and the opened lid projects downward therefrom.

### BRIEF DESCRIPTION OF THE DRAWINGS

FIG. 1 is a perspective view of an embodiment of the present invention.

FIG. 2 is a side view of an embodiment of the present invention.

FIG. 3 is a side view of an embodiment of the present invention in use.

FIG. 4 is a side view of an embodiment of the present invention in use.

FIG. 5 is a side view of an embodiment of the present invention in use.

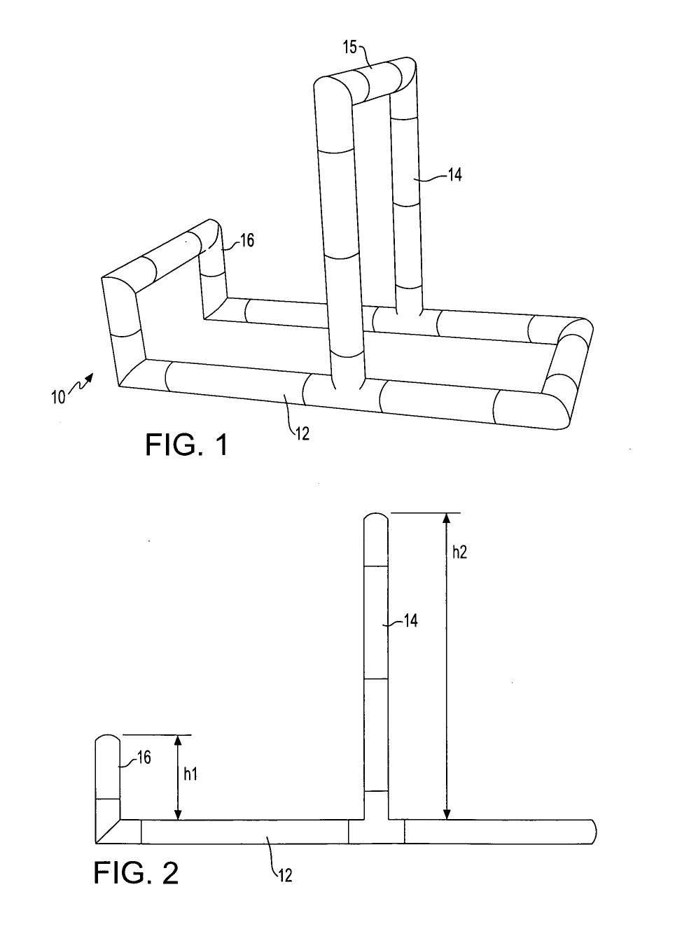

### DETAILED DESCRIPTION OF THE PRESENT INVENTION

The present invention will now be described in terms of the presently preferred embodiment thereof as illustrated in the drawings. Those of ordinary skill in the art will recognize that many obvious modifications may be made thereto without departing from the spirit or scope of the present invention.

The cooler drying frame 10 of the present invention is illustrated in the drawings. The frame 10 is presently contemplated to comprise a series of tubular structures although other equivalent structural elements can be substituted.

The frame 10 comprises a base section 12. In the embodiment illustrated in the drawings, the base section 12 is generally rectangular in shape. The base section 12 is intended to be oriented on a horizontal surface as shown in the drawings. The frame 10 further comprises a cooler support section 14. The cooler support section 14 is generally oriented in the vertical direction perpendicular to the base section 12. In this embodiment, the cooler support section 14 is generally rectangular in shape. The frame 10 further comprises a cooler lid support 16. The cooler lid support 16 is generally oriented in the vertical direction perpendicular to the base section 12. In this embodiment, the cooler lid support 16 is generally rectangular in shape. In general, the height, h1, of the cooler lid support 16 should be substantially less than the height, h2, of the cooler support section 14.

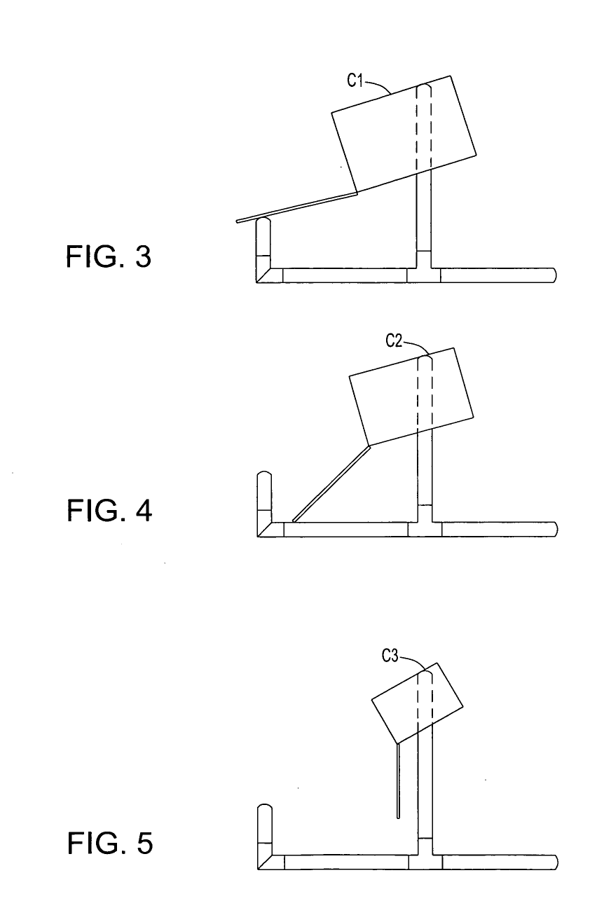

The use of the cooler drying frame 10 is illustrated in FIGS. 3 to 5 for various size coolers, C1, C2 and C3. The general concept is that the empty but wet cooler is inverted, the lid is raised and the cooler is placed over the cooler support section 14. The inside bottom surface of the cooler will rest upon the top rail 15 of the cooler support section 14. Depending upon the size of the cooler and the lid, the cooler lid may rest upon the cooler lid support 16 as shown in FIG. 3. Alternatively, for a somewhat shorter lid, the lid may rest upon the base section 12 as shown in FIG. 4. For a very small cooler, the lid may merely hang down without touching the frame as shown in FIG. 5.

In use, the cooler is placed on the drying frame 10. The force of gravity will cause some of the water to merely run out of the cooler. With the cooler lid open, any remaining moisture will evaporate from inside the cooler due to exposure to the ambient air. At that point after drying, the cooler may be stored with the lid closed.

It is also contemplated that the frame 10 could be attached to a vertical wall. In this case, the base section 12 would be attached flush to the vertical wall, and the cooler would merely be placed over the cooler support section 14. It is further contemplated that the frame 10 could also be adapted in size and shape for use with other items needing drying, such as large cooking pots.

Those of ordinary skill in the art will recognize the foregoing merely illustrates one embodiment of the present invention and that many obvious modifications may be made thereto without departing from the spirit or scope of the present invention as set forth in the appended claims.

What is claimed is:

1) A cooler drying frame comprising:
a) A base section;
b) A cooler support section connected to the base section comprising a first top support extending therefrom and generally perpendicular thereto; and
c) A lid support section connected to the base section comprising a second top support and extending therefrom and generally perpendicular thereto wherein the cooler support section is adapted to receive an inverted cooler with a opened lid thereon whereby an inside bottom surface of the cooler rests upon the first top support and the opened lid projects downward therefrom.

2) The cooler drying frame of claim 1 wherein the base section is adapted to be placed upon a horizontal surface.

3) The cooler drying frame of claim 1 wherein the base section is adapted to be placed upon a vertical surface.

4) The cooler drying frame of claim 1 wherein the lid support section is adapted to receive the opened lid in contact with the second top support.

5) A cooler and drying frame combination comprising:
a) A cooler comprising an interior bottom surface and an openable lid.
b) A drying frame comprising a base section, a cooler support section connected to the base section and extending therefrom and generally perpendicular thereto and a lid support section connected to the base section and extending upward therefrom and generally perpendicular thereto wherein the cooler support section is adapted to receive the cooler with the lid opened wherein the bottom inside surface of the cooler rests upon the cooler support section and the lid projects downward therefrom.

6) The cooler drying frame of claim 4 wherein the base section is adapted to be placed upon a horizontal surface.

7) The cooler drying frame of claim 4 wherein the base section is adapted to be placed upon a vertical surface.

8) The combination of claim 4 wherein the lid contacts the lid support section when the lid projects downward.
